(19) United States
(12) Patent Application Publication
(10) Pub. No.: US 2019/0095184 A1
(43) Pub. Date: Mar. 28, 2019

(54) METHOD OF INSTALLING SOFTWARE ON A HOST COMPUTER SYSTEM AND CORRESPONDING HOST COMPUTER SYSTEM

(71) Applicant: Fujitsu Technology Solutions Intellectual Property GmbH, Munich (DE)

(72) Inventors: Timo Bruderek, Munich (DE); Jurgen Atzkern, Munich (DE)

(21) Appl. No.: 16/144,163

(22) Filed: Sep. 27, 2018

(30) Foreign Application Priority Data
Sep. 28, 2017 (DE) 10 2017 122 625.7

(51) Int. Cl. G06F 8/61; G06F 9/455; H04L 29/08

(52) U.S. Cl. CPC G06F 8/61; G06F 2009/45595; H04L 69/327; G06F 9/45558

(57) ABSTRACT

A method of installing main operating software on a host computer system, including: setting up a connection from the host computer system to a repository server, wherein the host computer system keeps predetermined network ports used for the method closed such that no external connection establishment to the host computer system is permitted and access to the host computer system via the network by the network ports is therefore prevented; fetching the main operating software provided in a repository server by the host computer system; automatically installing the main operating software in the host computer system; and adopting a main operating state by the host computer system after the main operating software has been successfully installed, wherein the host computer system in the main operating state provides a main functionality going beyond a restricted functionality of the restricted operating state and is controlled by the main operating software.

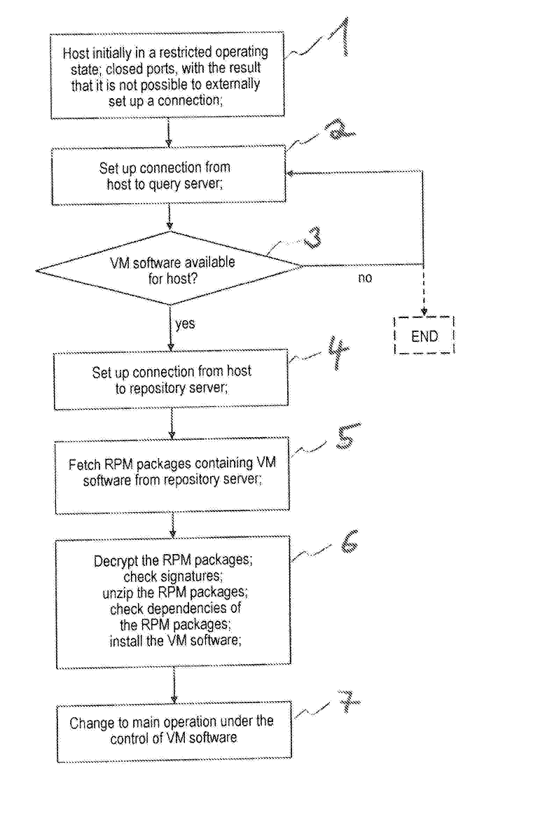

### TECHNICAL FIELD

This disclosure relates to a method of installing main operating software on a host computer system to be operated and an accordingly configured host computer system.

### BACKGROUND

The provision of main operating software, for example, a main operating system or one or more virtual machines, to set up or configure main operation of a host computer system by a remote repository server requires the host computer system to have opened communication network ports provided for this purpose in conventional orchestration methods, with the result that the repository server can set up a connection to the host computer system to roll out the main operating software on the host computer system. Conventional solutions, for example, Docker require a running software agent (service) on the part of the host computer system to be able to address the host computer system.

Such measures play an important role, in particular in industrial computer systems set up at an exposed place of use and have to be externally equipped with main operating software to set up running main operation for the purpose of providing an intended functionality. Such industrial computer systems may be, for example, control or monitoring systems for industrial plants, for example, wind power plants. Open communication network ports on the host computer system are problematic for security reasons and provide attackers from the network with the opportunity to manipulate the host computer system, which may have far-reaching consequences.

It could therefore be helpful to provide a method that enables simple software orchestration between a repository server and one or more host computer systems to load main operating software for the host computer systems and nevertheless ensures a high degree of security.

### SUMMARY

We provide a method of installing main operating software on a host computer system to be operated, wherein the host computer system is initially in a restricted operating state of restricted functionality, the method including; setting up a connection from the host computer system to a repository server to fetch the main operating software provided in the repository server by the host computer system, wherein the host computer system keeps predetermined network ports used for the method closed such that no external connection establishment to the host computer system is permitted and access to the host computer system via the network by the network ports is therefore prevented; fetching the main operating software provided in the repository server by the host computer system; automatically installing the main operating software in the host computer system; and adopting a main operating state by the host computer system after the main operating software has been successfully installed, wherein the host computer system in the main operating state provides a main functionality going beyond a restricted functionality of the restricted operating state and is controlled by the main operating software.

We also provide a host computer system that is initially in a restricted operating state of restricted functionality and configured to set up a connection to a repository server to fetch main operating software provided in the repository server, wherein the host computer system, however, keeps network ports closed with respect to the repository server such that no external connection establishment from the repository server to the host computer system is permitted and access to the host computer system via the network by the network ports is therefore prevented, and wherein the host computer system is set up to fetch the main operating software provided in the repository server to automatically install the main operating software in the host computer system and assume a main operating state after the main operating software has been successfully installed, wherein the host computer system in the main operating state provides a main functionality going beyond the restricted functionality of the restricted operating state and can be controlled by the main operating software.

We further provide a computer network infrastructure including the host computer system and a repository server to provide main operating software for the host computer system.

### BRIEF DESCRIPTION OF THE DRAWING

The FIGURE shows a schematic sequence of a method of installing main operating software on a host computer system (host below) to be operated.

### DETAILED DESCRIPTION

Our method is used to install main operating software on a host computer system to be operated. The main operating software is used for main operation of the computer system. In a main operating state, the host computer system is supposed to provide an intended main functionality. For example, the host computer system is supposed to operate as a monitoring PC to monitor a plant, for example, an industrial plant such as a wind power plant, in the main operating state. The intended main functionality of the host computer system can be set up (implemented) by providing, loading and installing the main operating software. However, the intended main functionality is not (yet) possible before the main operating software is installed. Rather, the host computer system is initially (initially when starting the method) in a restricted operating state with restricted functionality. In this restricted operating state, the host computer system is switched on and ready (ready state) in so far as it is in an running basic state without errors. In this case, the host computer system has a restricted functionality different from the intended main functionality of a main operating state (to be assumed according to the method), in particular is more limited in its range of functions. For example, in the restricted operating state, a minimal operating system (basic operating system) can be installed and can run. The restricted operating state can be implemented such that only a connection from the host computer system to a repository server can be set up and main operating software fetched from there can be installed, but main operation of the host computer system is not (yet) possible (owing to a lack of installed main operating software).

The following steps are carried out according to the method. A connection is first of all set up from the host computer system to a repository server for the purpose of fetching the main operating software provided in the repository server by the host computer system. The host computer system keeps predetermined network ports used for this method closed such that it is not permitted to externally set up a connection to the host computer system and access to the host computer system via the network by the network ports is therefore prevented. The main operating software provided in the repository server is then fetched by the host computer system using the connection to the repository server that has been set up by the host computer system itself. This measure can comprise authentication of the host computer system at the repository server (for example, by comparing a transmitted passphrase, credential or the like with a stored passphrase, credential or the like). After the host computer system has been successfully authenticated, the main operating software can then be downloaded from the repository server by the host computer system.

The main operating software is then automatically installed in the host computer system. Such installation can be initiated and controlled in an automated manner, for example, using a script. The host computer system then assumes a main operating state (of the type explained above) after the main operating software has been successfully installed. This means that the host computer system changes from the restricted operating state to the main operating state. In the main operating state, the host computer system provides a main functionality that goes beyond the restricted functionality of the restricted operating state and is controlled by the installed main operating software.

The term “predetermined network ports” means that all or only selected security-critical network ports, for example, the network ports used for this method for the purpose of interchanging the main operating software, are permanently or temporarily closed in the host computer system according to the above functionality. This has the advantage that no programs or services that listen to the corresponding network ports from the outside for the purpose of addressability or for the purpose of setting up a connection to the host computer system and which form a potential security gap (for example, caused by buffer overflow or the like) are set up or required on the host computer system. In this context, “closed network ports” means that these are not “listening ports”, that is to say it is not permitted to externally set up a connection. A remote computer system, in particular the repository server, is not able in this case to be externally authenticated at the host computer system or externally log onto the host computer system via the network, for example, via a secure shell (SSH) daemon in the case of UNIX-based systems, or initiate or carry out specific actions on the host computer system. However, as described above, the host computer system can in turn set up a connection to the repository server (and possibly to further remote computer systems) via the network to address queries to these computer systems and specifically to fetch the main operating software from the repository server.

In this manner, our method makes it possible to easily load (orchestrate) and set up main operating software for a host computer system and nevertheless ensures a very high degree of security on account of the (blocked) network ports closed for connection attempts coming from the outside.

One possible application of our method is, for example, setting-up a host computer system with an intended main functionality that is controlled via the main operating software, wherein the host computer system is set up as an industrial PC at an exposed place of use. For example, the host computer system can be used as a control installation in a wind power plant, for example, on a wind turbine.

In various implementations of the method, the host computer system queries the repository server or a separate query server to determine whether main operating software is available in the repository server. In this case, the host computer system can carry out polling with respect to the repository server or the query server, for example. The polling can be carried out, for example, using a computing manager specifically set up for this purpose. In this manner (after it has been installed at the place of use), the host computer system can check at particular intervals of time whether main operating software or an update for the latter is available.

In various implementations of the method, the host computer system sets up a connection to a separate query server and receives a push notification from the query server via the connection which has been set up as soon as main operating software is available in the repository server. The connection to the query server is carried out according to the Message Queue Telemetry Transport (MQTT) protocol, for example. In this case, the query server may comprise an MQTT service or may be a special MQTT server.

In various implementations of the method, the repository server provides the host computer system with one or more software packages containing the data needed to install the main operating software. In addition to the main operating software (in particular binary program files, configuration files, data files or the like), the one or more software packages may also comprise a script to automatically install the main operating software. After the software package has been unzipped, this script is automatically called up and executed and controls the installation of the main operating software. As a result of the packaging and automatic installation, the main operating software can be easily and efficiently rolled out onto the host computer system.

In various implementations of the method, a package management system that manages and processes the one or more software packages is set up in the host computer system. The package management system can access the repository server or a corresponding service implemented in the repository server to fetch software packages to install the main operating software from the repository server. The package management system can be set up as an RPM package manager, for example. An organization of the method using a package management system generally makes it possible to easily manage and process the software packages and the information contained therein such as binary program files, configuration files and metadata which comprise the name, function, dependencies, initialization scripts and the like of a respective software package. If an RPM package manager is used, it is possible to provide a so-called delta RPM functionality. In this case, in the event of updates to the main operating software, only data which contain changes/differences/overflows (delta) with respect to a data stock of an originally transmitted installation package are transmitted from the repository server. This makes it possible to load updates quickly and with a low volume of data. This is advantageous, in particular, in low-performance data rates of a network, in particular in network connections with narrow bandwidths, as can occur at exposed places of use of a host computer system.

The package management system can also provide further functionalities, for example, encryption/decryption of software packages, signing of software packages with a (qualified electronic) signature or dependency management between a plurality of software packages. The latter is advantageous to have to transmit contents such as data, libraries and the like, used/required by a plurality of entities of the main operating software (for example, one or more virtual machines), only once and in a non-redundant manner in software packages. These contents can be provided, for example, as a so-called backing software image used by all entities dependent thereon and whose dependencies are taken into account in the dependency management. Dependency management can generally map which software packages are required during final installation of the main operating software. These packages can be captured, for example, in a dependency database, and can be automatically incorporated in the exchange process between the repository server and the host computer system. The use of a package management system, in particular an RPM package manager, in the method explained here therefore generally provides many advantages.

In various implementations of the method, the main operating software comprises one or more virtual machines. When installed and executed on the host computer system, the at least one virtual machine provides a virtual host computer system or a virtual main operating system. As a result, a main operating state of the host computer system can be adapted in a very flexible manner for the purpose of providing/controlling one or more particular desired main functionalities of the host computer system. For example, the host computer system in the main operating state can host two virtual machines, wherein one virtual machine provides a client and the other virtual machine provides a server. Both virtual machines can be easily set up in a fully functional manner, not least owing to package management of the type explained above.

We also provide a host computer system and a computer network infrastructure having such a host computer system and a repository server that provides main operating software for the host computer system. The advantages explained above emerge in a similar manner here.

Our methods are explained in more detail below with the aid of a FIGURE.

The main operating software is provided, by way of example, as software of one or more virtual machines (VM software). The host is set up, by way of example, as an industrial PC at an exposed place of use. For example, the host is set up as a control installation in a wind power plant, for example, on a wind turbine.

In a first step 1, the host is initially in a restricted operating state of restricted functionality. In this restricted operating state, the host is switched on and in a ready state in which it runs without errors. A minimal operating system (basic operating system) runs in this case. In the restricted operating state, only a connection from the host to a repository server is possible for the purpose of installing the VM software which can be fetched from there by means of the host, as explained below. However, no main operation is possible (yet) in this state of the host owing to a lack of installed VM software.

Furthermore, the host keeps selected or all network ports closed at least with respect to the repository server or alternatively with respect to all possible remote computer systems that can be connected via a network, however, such that it is not permitted to externally set up a connection to the host and access to the host via the network by these network ports is therefore prevented. In this respect, the host is therefore encapsulated and cannot be externally addressed via the network.

In a step 2, however, the host in turn sets up a connection to a specially configured, remote query server and carries out a query (polling) with respect to the query server to determine whether VM software is available in the repository server. The polling can be carried out, for example, using a computing manager specifically set up for this purpose in the host and implemented in the minimal operating system of the host. In this manner (after it has been installed at the place of use), the host can check at particular intervals of time whether VM software or an update for the latter is available.

Alternatively, the host sets up a connection to the query server and receives a push notification from the query server via the (available) connection that has been set up as soon as a version of the VM software intended for the host is available in the repository server. The connection to the query server is an MQTT connection, for example. In this case, the query server may comprise an MQTT service or may be a special MQTT server.

Further alternatively, the host immediately sets up a connection to the repository server and queries whether a version of the VM software intended for it is available in the repository server.

If a query in step 3 reveals that a version of the VM software is available in the repository server, the host sets up a connection to the repository server in step 4 for the purpose of fetching the VM software provided in the repository server by the host. If the query in step 3 reveals that a valid version of the VM software is not available in the repository server, the method is either terminated or the host returns to a state in which it again carries out (after a particular time) a corresponding query according to step 2 to check the availability of VM software in the repository server.

Assuming that a version of the VM software is available in the repository server, the host fetches one or more software packages from the repository server in step 5 via the connection that has been set up to the repository server. In the example according to the FIGURE, the software packages are in the form of RPM packages managed using an RPM package manager.

After the RPM packages have been transmitted, the host (optionally) decrypts the RPM packages, checks one or more signatures of the RPM packages and unzips the RPM packages. Furthermore, dependencies of the RPM packages can also be checked in this step to ensure that the VM software is installed in a correct and unbroken manner. If these measures have been successfully run through, the VM software from the unzipped RPM packages is actually installed. The installation can take place automatically by one or more control scripts. The installation can then be carried out without the need for an administrator to intervene in situ or by remote maintenance.

After the VM software has been successfully installed in step 6, the host finally changes to the main operating state in step 7, wherein the host in the main operating state provides a main functionality that goes beyond the restricted functionality of the restricted operating state and controlled by the installed and running VM software. The method is then terminated.

In this manner, main operation of the host can be set up in a simple and nevertheless secure manner. For example, two or more virtual machines can run in a parallel manner in the main operating state of the host, which virtual machines implement different functionalities and are implemented using accordingly installed VM software. For example, one virtual machine may be a client and the other virtual machine may be a server for particular applications of the host at its place of use.

Although the apparatus and methods have been described in connection with specific forms thereof, it will be appreciated that a wide variety of equivalents may be substituted for the specified elements described herein without departing from the spirit and scope of this disclosure as described in the appended claims.

What is claimed is:

1. A method of installing main operating software on a host computer system to be operated, wherein the host computer system is initially in a restricted operating state of restricted functionality, the method comprising:
setting up a connection from the host computer system to a repository server to fetch the main operating software provided in the repository server by the host computer system, wherein the host computer system keeps predetermined network ports used for the method closed such that no external connection establishment to the host computer system is permitted and access to the host computer system via the network by the network ports is therefore prevented,
fetching the main operating software provided in the repository server by the host computer system,
automatically installing the main operating software in the host computer system, and
adopting a main operating state by the host computer system after the main operating software has been successfully installed, wherein the host computer system in the main operating state provides a main functionality going beyond a restricted functionality of the restricted operating state and is controlled by the main operating software.

2. The method according to claim 1, wherein the host computer system queries the repository server or a separate query server to determine whether main operating software is available in the repository server.

3. The method according to claim 1, wherein the host computer system sets up a connection to a separate query server and receives a push notification from the query server via the connection that has been set up as soon as main operating software is available in the repository server.

4. The method according to claim 3, wherein the connection to the query server is carried out according to the Message Queue Telemetry Transport (MQTT) protocol.

5. The method according to claim 1, wherein the repository server provides the host computer system with one or more software packages containing the data needed to install the main operating software.

6. The method according to claim 5, wherein a package management system of managing and processing the one or more software packages is set up in the host computer system, and the package management system accesses the repository server to fetch software packages from the repository server.

7. The method according to claim 1, wherein the main operating software comprises at least one virtual machine.

8. A host computer system that is initially in a restricted operating state of restricted functionality and configured to set up a connection to a repository server to fetch main operating software provided in the repository server, wherein the host computer system, however, keeps network ports closed with respect to the repository server such that no external connection establishment from the repository server to the host computer system is permitted and access to the host computer system via the network by the network ports is therefore prevented, and wherein the host computer system is set up to fetch the main operating software provided in the repository server to automatically install the main operating software in the host computer system and assume a main operating state after the main operating software has been successfully installed,
wherein the host computer system in the main operating state provides a main functionality going beyond the restricted functionality of the restricted operating state and can be controlled by the main operating software.

9. A computer network infrastructure comprising the host computer system according to claim 8 and a repository server to provide main operating software for the host computer system.

10. The method according to claim 2, wherein the repository server provides the host computer system with one or more software packages containing the data needed to install the main operating software.

11. The method according to claim 3, wherein the repository server provides the host computer system with one or more software packages containing the data needed to install the main operating software.

12. The method according to claim 4, wherein the repository server provides the host computer system with one or more software packages containing the data needed to install the main operating software.

13. The method according to claim 2; wherein the main operating software comprises at least one virtual machine.

14. The method according to claim 3, wherein the main operating software comprises at least one virtual machine.

15. The method according to claim 4, wherein the main operating software comprises at least one virtual machine.

16. The method according to claim 5, wherein the main operating software comprises at least one virtual machine.

17. The method according to claim 6, wherein the main operating software comprises at least one virtual machine.
